(19) United States
(12) Patent Application Publication
(10) Pub. No.: US 2019/0299504 A1
(43) Pub. Date: Oct. 3, 2019

(54) METHOD FOR MANUFACTURING AN ELASTIC STRUCTURE BETWEEN TWO OBJECTS

(71) Applicant: CONCRAFT HOLDING CO., LTD., Grand Cayman (KY)

(72) Inventors: Chang-Hsien TUNG, New Taipei City (TW); Zheng-Xiang WANG, Kunshan City (CN)

(21) Appl. No.: 16/053,028

(22) Filed: Aug. 2, 2018

(30) Foreign Application Priority Data
Mar. 30, 2018 (TW) 107111259

(51) Int. Cl. B29C 45/14; B29C 45/26

(52) U.S. Cl. CPC B29C 45/14508; B29C 45/14065; B29C 45/14778; B29K 2083/00; B29C 2045/14122; B29C 2045/1454; B29C 45/26

(57) ABSTRACT

A method for manufacturing an elastic structure between two objects, in which the manufacturing method primarily consists of disposing a first object and a second object into a mold having a molding space and a flow channel, causing portions of the first object and the second object to protrude within the molding space; injecting a liquid plastic material into the molding space, causing the plastic material to cover the portions of the first object and the second object protruding into the molding space; and forming the elastic structure that connects between the first object and the second object after the liquid plastic material cools down and takes shape within the molding space. The elastic structure formed comprises two connecting portions respectively covering the first object and the second object, and an elastic portion located between the two connecting portions.

### BACKGROUND OF THE INVENTION

### (a) Field of the Invention

The present invention relates to a method for manufacturing an elastic structure between two objects, and more particularly to an elastic structure that provides an up/down displacement function between two objects having application in acoustic diaphragms or touch screens of notebook computers.

### (b) Description of the Prior Art

For the purpose of convenient portability, there is the gradual development trend towards greater thinness in current mobile devices, such as smart cell phones or tablet computers. And in order to achieve the requirements for thinness of mobile devices, it is necessary to reduce the size and thickness of each of the components within the mobile device to enable containing the components therein and satisfy the requirement for the thinning tendency.

Furthermore, apart from the requirement to satisfy the thinning tendency of mobile devices, there is also the requirement for very high quality sound. Accordingly, with the thinning tendency of mobile devices, providing the mobile device with a miniaturized speaker able to present high quality sound is a huge challenge for current mobile devices.

For example, U.S. Pat. No. 9,820,066 provides a micro speaker, comprising a diaphragm and a voice coil that drives and vibrates the diaphragm to produce sound. The diaphragm comprises a conductive dome and a suspension surrounding the conductive dome. The micro speaker further comprises a conductive front cover positioned on the conductive dome, and a capacitor structure formed between the conductive front cover and the conductive dome. When the diaphragm vibrates, the electrical signal output by the capacitor structure causes an instantaneous feedback that effects a vibration displacement of the diaphragm, thus providing a technical disclosure able to realize instantaneous and accurate feedback that effects vibration displacement of a diaphragm.

However, during manufacture, after separately forming the aforementioned diaphragm and conductive dome, the conductive dome is then adhered to the diaphragm. In other words, only a single adhesive surface is used between the conductive dome and the diaphragm, hence, continuous mutual pulling at the adhesive area between the conductive dome and the diaphragm results when the diaphragm produces a vibration displacement. And when the adhesive bond is no longer reliable, then separation between the conductive dome and the diaphragm easily occurs, further shortening the serviceable life of the entire micro speaker.

Accordingly, the objectives of the present invention involves resolving the technical problems that enable increasing the adhesivity between the conductive dome and the diaphragm while concurrently maintaining the elasticity between the conductive dome and the diaphragm.

### SUMMARY OF THE INVENTION

The main object of the present invention lies in providing a method for manufacturing an elastic structure between two objects, and more particularly to an elastic structure that provides an up/down displacement function between two objects having application in acoustic diaphragms or touch screens of notebook computers.

In order to achieve the aforementioned object, the method for manufacturing an elastic structure between two objects of the present invention comprises the following steps: Step a: Providing a first object having at least one first side edge. Step b: Providing a second object having at least one second side edge. Step c: Providing a mold, wherein at least one molding space and at least one flow channel that affords passage to the molding space are provided within the mold, moreover, the molding space comprises a curved section and two connecting sections respectively located on two sides of the curved section. Step d: Respectively disposing the first object and the second object into the mold, causing a portion of the first object to protrude into one of the connecting sections, and a portion of the second object to protrude into the other connecting section, thereby causing the first side edge and the second side edge to be mutually corresponding and mutually separated within the molding space. Step e: Injecting a liquid plastic material into the molding space, causing the plastic material to cover the portions of the first object and the second object protruding into the molding space, enabling the liquid plastic material to cool down and take shape within the molding space to form an elastic structure that connects between the first object and the second object. And Step f: Extracting the first object, the second object, and the elastic structure from within the mold, wherefrom the elastic structure comprises two connecting portions that respectively cover the first object and the second object and an elastic portion located between the two connecting portions.

In one embodiment, the first object and the second object are manufactured from metallic material.

In one embodiment, the first object is manufactured from metallic material, and the second object is manufactured from plastic material.

In the embodiment, the plastic material is silicone.

In one embodiment, the interior of the mold further comprises a first positioning section used to fix the first object and a second positioning section used to fix the second object. Moreover, the first positioning section extends from one of the connecting sections, and the second positioning section extends from the other connecting section.

In the embodiment, the mold comprises a first mold seat and a second mold seat corresponding to the first mold seat and mutually assembled therewith.

In the embodiment, the interior of the first mold seat is provided with a first groove and the second mold seat is provided with a second groove corresponding to the first groove, with the molding space assembled from the first groove and the second groove.

In the embodiment, a first curved portion is further provided inside the first groove, and the interior of the second groove is further provided with a second curved portion corresponding to the first curved portion, moreover, the curved sections are formed from the first curved portion and the second curved portion.

In the embodiment, the first curved portion assumes a protruding portion inside the first groove, and the second curved portion assumes an indented portion inside the second groove.

In the embodiment, the flow channel is located in the first mold seat to afford passage to the first groove.

The method for manufacturing an elastic structure between two objects is provided with the following advantages compared to the prior art:

The present invention uses an injection molding method to form the elastic structure between the first object and the second object, moreover, the elastic structure comprises connecting portions that respectively cover the first object and the second object and an elastic portion located between the two connecting portions. The elastic structure is thus able to prevent separation from occurring when carrying out up/down elastic displacement states of the first object and the second object using the elastic portion.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 is a three-dimensional view of a first embodiment of an elastic structure of the present invention.

FIG. 2 is an exploded view of the first embodiment of the elastic structure of the present invention.

FIG. 3 is a cross-sectional view of the first embodiment of the elastic structure of the present invention.

FIG. 4 is a cross-sectional view of a mold provided by the present invention.

FIG. 5 is an exploded cross-sectional view of the mold provided by the present invention.

FIG. 6 is a three-dimensional view of a second embodiment of the elastic structure of the present invention.

FIG. 7 is a cross-sectional view of the second embodiment of the elastic structure of the present invention.

FIG. 8 is a three-dimensional view of a third embodiment of the elastic structure of the present invention.

FIG. 9 is a cross-sectional view of the third embodiment applied in a micro speaker according to the present invention.

### DETAILED DESCRIPTION OF THE PREFERRED EMBODIMENTS

Regarding the detailed content and structural means of present invention, please refer to the description of the diagrams as follows:

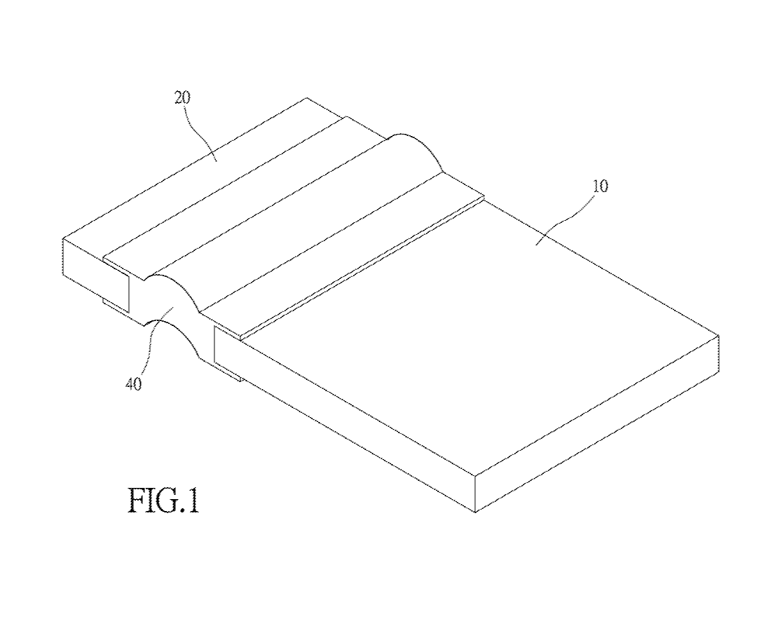

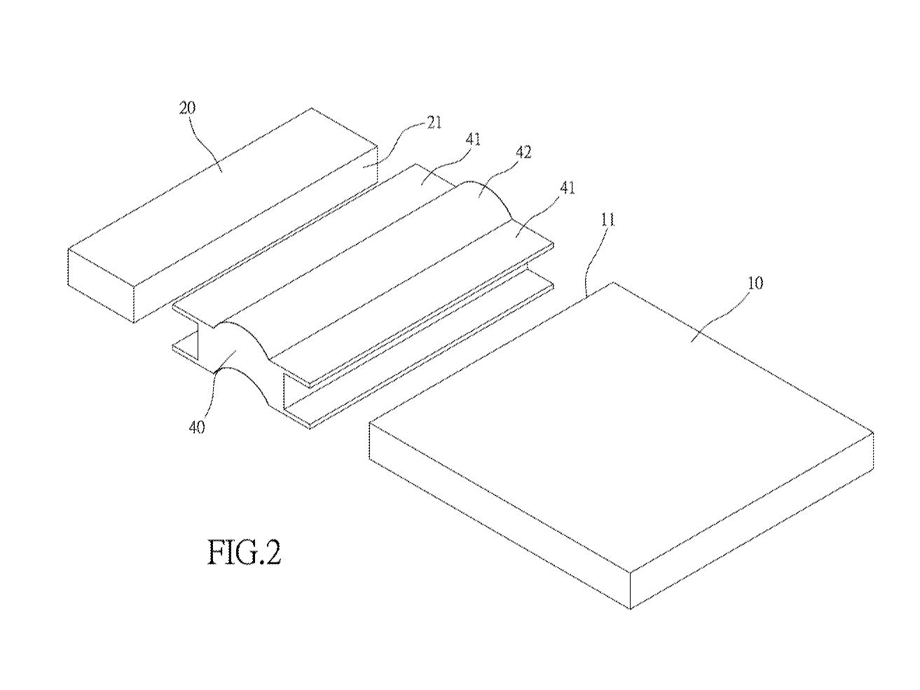

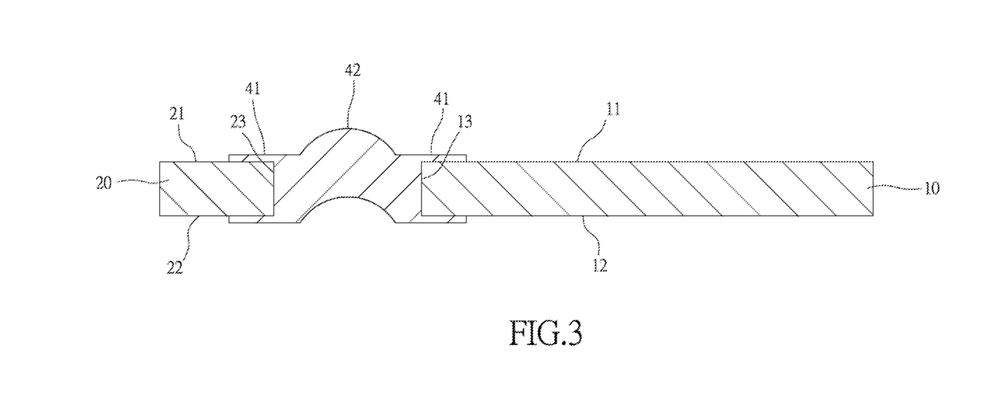

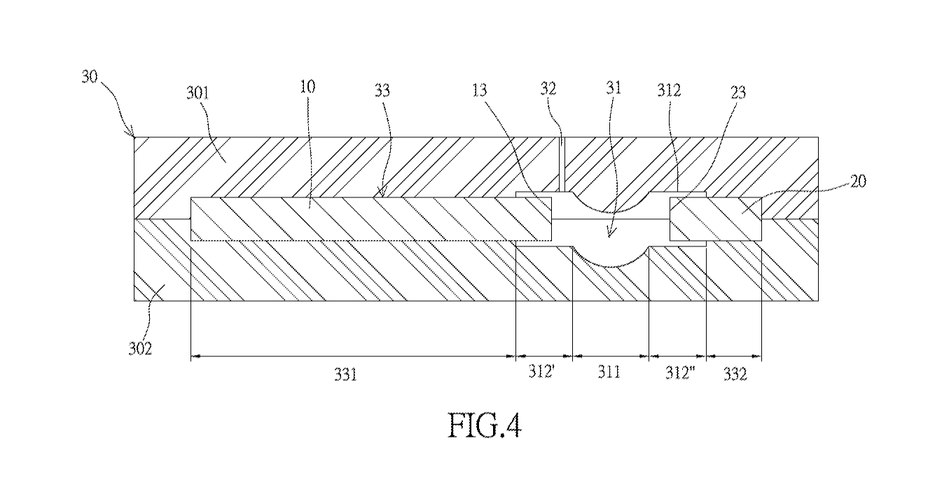

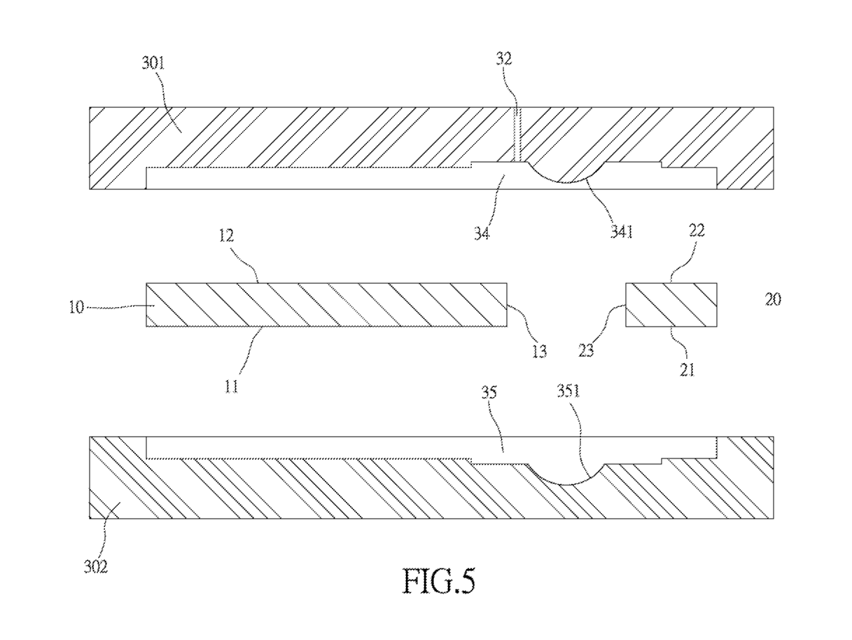

Referring to FIGS. 1 to 5, which show a first embodiment of the present invention, wherein the present invention provides a method for manufacturing an elastic structure between two objects, comprising the following steps:

Step a: Providing a first object 10, wherein the first object 10 is provided with a first upper surface 11, a first lower surface 12 corresponding to the first upper surface 11, and at least one first side edge 13 that connects between the first upper surface 11 and the first lower surface 12.

Step b: Providing a second object 20, wherein the second object 20 is provided with a second upper surface 21, a second lower surface 22 corresponding to the second upper surface 21, and at least one second side edge 23 that connects between the second upper surface 21 and the second lower surface 22.

Step c: Providing a mold 30, wherein at least one molding space 31 and at least one flow channel 32 that affords passage to the molding space 31 are provided within the mold 30, moreover, the molding space 31 comprises a curved section 311 and two connecting sections 312 respectively located on two sides of the curved section 311. The connecting sections 312 comprise a first connecting section 312′ and a second connecting section 312″ corresponding to the first connecting section 312′.

Step d: Respectively disposing the first object 10 and the second object 20 into the mold 30, causing a portion of the first object 10 to protrude into one of the connecting sections 312, and a portion of the second object 20 to protrude into the other connecting section 312, thereby causing the first side edge 13 and the second side edge 23 to be mutually corresponding and mutually separated within the molding space 31. In the present embodiment, the first object 10 protrudes into the interior of the first connecting section 312′, and the second object 20 protrudes into the interior of the second connecting section 312″.

Step e: Injecting a liquid plastic material (not shown in the drawings) into the molding space 31 through the flow channel 32, causing the plastic material to cover the portions of the first object 10 and the second object 20 protruding into the molding space 31, enabling the liquid plastic material to cool down and take shape within the molding space 31 to form an elastic structure 40 that connects between the first object 10 and the second object 20. In the present embodiment, the plastic material is a silicone having adhesive properties as the primary application mode.

Step f: Extracting the first object 10, the second object 20, and the elastic structure 40 from within the mold 30, wherefrom the elastic structure 40 comprises two connecting portions 41 that respectively cover the first object 10 and the second object 20 and an elastic portion 42 located between the two connecting portions 41.

In the present embodiment, the interior of the mold 30 further comprises two positioning sections 33 that are respectively used to fix the first object 10 and the second object 20. The two positioning sections 33 comprise a first positioning section 331 used to fix the first object 10 and extends from the first connecting section 312′, and a second positioning section 332 used to fix the second object 20 and extends from the second connecting section 312″. Thus, the first object 10 and the second object 20 are stably fixed within the mold 30 using the first positioning section 331 and the second positioning section 332. In addition, the mold 30 is assembled from a first mold seat 301 and a second mold seat 302 corresponding to the first mold seat 301 and assembled therewith. Moreover, a first groove 34 is provided in the first mold seat 301, and a second groove 35 is provided in the second mold seat 302 corresponding to the first groove 34. Accordingly, the molding space 31 is assembled from the first groove 34 and the second groove 35. In addition, a first curved portion 341 is provided inside the first groove 34, and a second curved portion 351 is provided inside the second groove 35, wherein the first curved portion 341 assumes a protruding portion inside the first groove 34, and the second curved portion 351 forms an indented portion inside the second groove 35. The curved section 311 is thereby assembled from the first curved portion 341 and the second curved portion 351.

The first object 10 and the second object 20 are located within the molding space 31 using partially protruding means when disposed within the mold 30, causing the first object 10 and the second object 20 to respectively form a clearance with the groove bottoms of the first groove 34 and the second groove 35. Accordingly, after a liquid plastic material enters the molding space 31 through the flow channel 32, the space between the curved section 311 and the two connecting sections 312 is filled up, moreover, the plastic material fills the space within the clearances formed between the first object 10, the second object 20, the first groove 34, and the second groove 35.

Accordingly, after the plastic material cools and takes shape within the molding space 31, two connecting portions 41 are formed that cover portions of the first upper surface 11, the first lower surface 12, the first side edge 13, the second upper surface 21, the second lower surface 22, and the second side edge 23, wherein the connecting portions 41 respectively assume a sideward square-U shape facing opposite directions, enabling each of the connecting portions 41 to respectively use at least a three-surface method to join together the first object 10 and the second object 20. After the plastic material located within the curved section 311 cools and forms a shape, the elastic portion 42 is formed having a shape identical to the first curved portion 341 and the second curved portion 351. Accordingly, the two connecting portions 41 and the elastic portion 42 are used to form the elastic structure 40 connected between the first object 10 and the second object 20.

Furthermore, in the present embodiment, the plastic material uses a silicone having adhesive properties, thus, the first object 10 and the second object 20 can be formed from metallic material, plastic material, or other materials which are able to bond to the plastic material. In addition, the plastic material can also be rubber or other plastic material having elastic and adhesion properties. Hence, because the elastic structure 40 is manufactured from plastic material, thus, the elastic portion 42 is able to assume a curved form having an elastic resetting force, which further enables the elastic portion 42 connected between the two connecting portions 41 to form an elastic displacement mode between the two connecting portions 41. Hence, when the first object 10 and the second object 20 are respectively connected to the two connecting portions 41, then mutually relative up/down displacement elastic states can be effected between the first object 10 and the second object 20 through the elastic displacement mode.

Accordingly, using the elastic structure 40 formed by the present invention enables the elastic structure 40 to respectively form at least a three-surface join with the first object 10 and the second object 20, further enabling an increase in the joining strength between the first object 10, the second object 20, and the elastic structure 40, as well preventing separation from occurring when carrying out up/down elastic displacement states of the first object 10 and the second object 20 using the elastic portion 42.

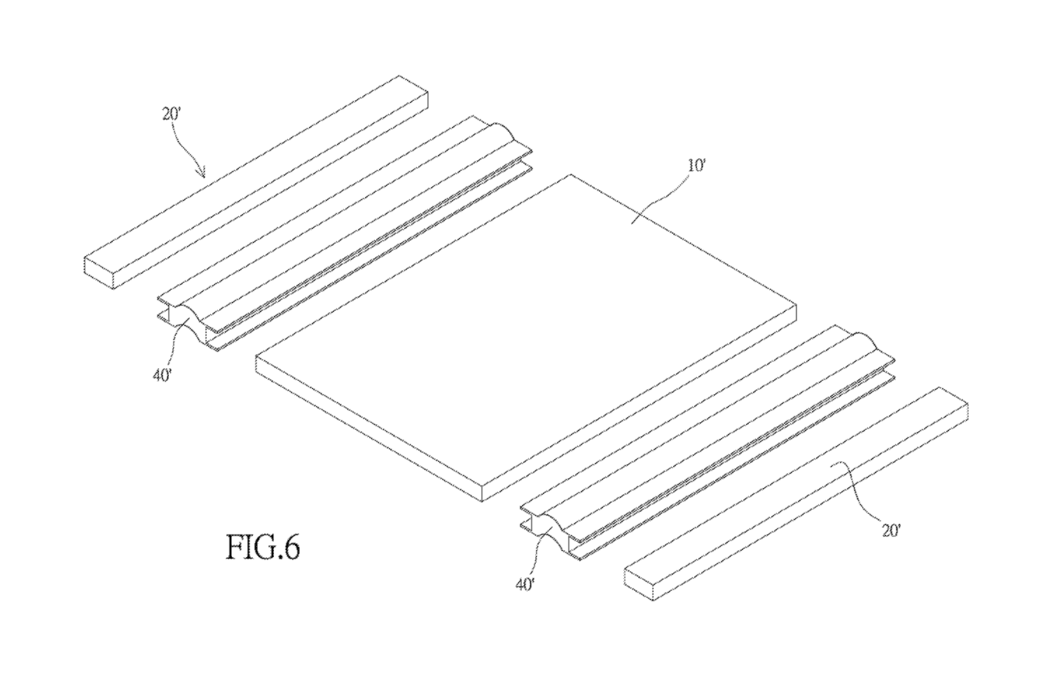

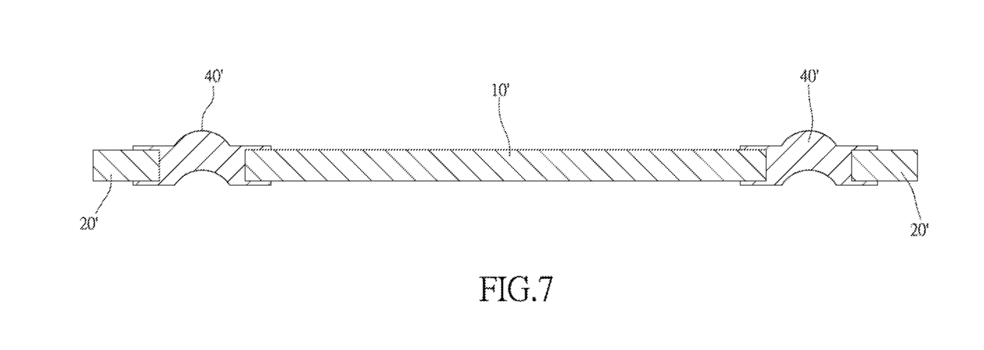

Referring to FIGS. 6 and 7, which show a second embodiment of an elastic structure formed by the method of the present invention, wherein a first object 10′ assumes a plate-form object, and two sides of the first object 10′ are respectively provided with a second object 20′. The two second objects 20′ are respectively separated from the first object 10′, and elastic structures 40′ are respectively connected between the two second objects 20′ and the first object 10′, thereby enabling the first object 10′ to form up/down elastic displacement states between the two second objects 20′. Such a structural design has application in touch keys of notebook computers.

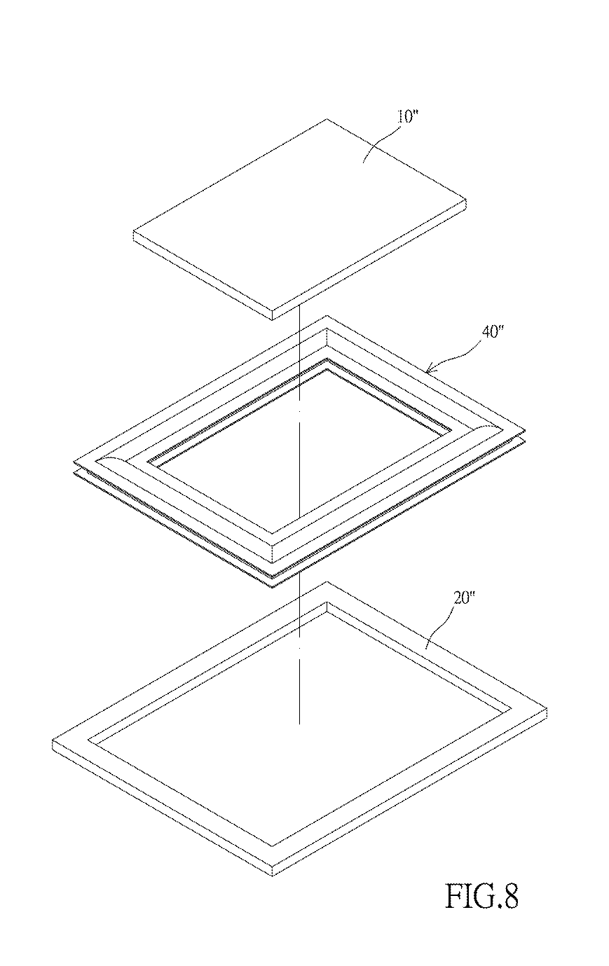

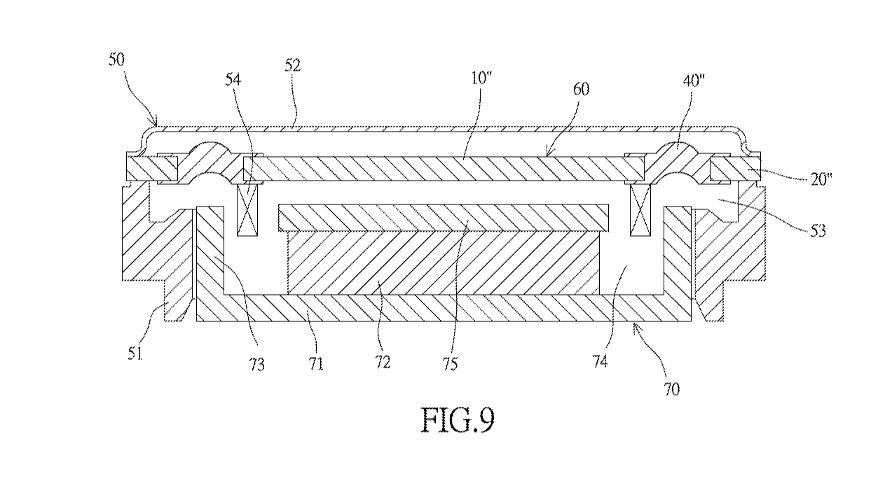

Further referring to FIGS. 8 and 9, which show a third embodiment of an elastic structure formed by the method of the present invention, and in the third embodiment, a first object 10″ is similarly a plate-form object, and a second object 20″ is a frame that is circumferentially located on the periphery but separated from the first object 10″, and an elastic structure 40″ circumferentially connected between the plate-formed first object 10″ and the frame-formed second object 20″.

Such a structure has application in the interior of a micro speaker 50, wherein the first object 10″, the second object 20″, and the elastic structure 40″ are used to assemble and form a diaphragm 60. The diaphragm 60 is disposed within a retaining space 53 formed by a speaker stand 51 of the micro speaker 50 and a conductive cover plate 52. Moreover, a voice coil 54 used to drive and vibrate the diaphragm 60 is disposed on the diaphragm 60, more specifically, the voice coil 54 is disposed on the bottom portion of the elastic structure 40″. In addition, the interior of the retaining space 53 further comprises a magnetic circuit system 70, which comprises a lower clamp plate 71, a first magnet portion 72 disposed on the lower clamp plate 71, and a second magnet portion 73, wherein at least one of the first magnet portion 72 and the second magnet portion 73 is a permanent magnet. The second magnet portion 73 encircles the disposition of the first magnet portion 72 and forms a magnetic space 74 between the first magnet portion 72 and the second magnet portion 73. The voice coil 54 is disposed within the magnetic space 74, with the magnetic circuit system 70 further comprising a pole piece 75 attached to the first magnet portion 72.

Accordingly, when the voice coil 54 is used to drive and vibrate the diaphragm 60 assembled from the first object 10″, the second object 20″, and the elastic structure 40″, the first object 10″ creates an up/down displacement elastic state between the second object 20″ through the elastic structure 40″, while concurrently preventing separation of the first object 10″ and the second object 20″ from occurring using the elastic structure 40″ effecting an up/down elastic displacement mode. Hence, the third embodiment of the present invention is able to substantially increase the serviceable life of the micro speaker 50 while concurrently effecting an immediate feedback vibration displacement.

In conclusion, the present invention clearly complies with the essential elements as required for a new invention patent, thus, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A method for manufacturing an elastic structure between two objects, comprising steps of:
a) providing a first object, wherein the first object is provided with at least one first side edge;
b) providing a second object, wherein the second object is provided with at least one second side edge;
c) providing a mold, wherein at least one molding space and at least one flow channel that affords passage to the molding space are provided within the mold, moreover, the molding space comprises a curved section and two connecting sections respectively located on two sides of the curved section;
d) respectively disposing the first object and the second object into the mold, causing a portion of the first object to protrude into one of the connecting sections and a portion of the second object to protrude into the other connecting section, thereby causing the first side edge and the second side edge to be mutually corresponding and mutually separated within the molding space;
e) injecting a liquid plastic material into the molding space, causing the plastic material to cover the portions of the first object and the second object protruding into the molding space, enabling the liquid plastic material to cool down and take shape within the molding space to form an elastic structure that connects between the first object and the second object; and
f) extracting the first object, the second object, and the elastic structure from within the mold, wherefrom the elastic structure comprises two connecting portions that respectively cover the first object and the second object and an elastic portion located between the two connecting portions.

2. The method for manufacturing an elastic structure between two objects according to claim 1, wherein the first object and the second object are manufactured from metallic material.

3. The method for manufacturing an elastic structure between two objects according to claim 1, wherein the first object is manufactured from metallic material, and the second object is manufactured from plastic material.

4. The method for manufacturing an elastic structure between two objects according to claim 1, wherein the plastic material is silicone.

5. The method for manufacturing an elastic structure between two objects according to claim 1, wherein the interior of the mold further comprises a first positioning section used to fix the first object and a second positioning section used to fix the second object; moreover, the first positioning section extends from one of the connecting sections, and the second positioning section extends from the other connecting section.

6. The method for manufacturing an elastic structure between two objects according to claim 1, wherein the mold comprises a first mold seat and a second mold seat corresponding to the first mold seat and assembled therewith.

7. The method for manufacturing an elastic structure between two objects according to claim 6, wherein the interior of the first mold seat is provided with a first groove and the second mold seat is provided with a second groove corresponding to the first groove, with the molding space assembled from the first groove and the second groove.

8. The method for manufacturing an elastic structure between two objects according to claim 7, wherein a first curved portion is further provided inside the first groove, and the interior of the second groove is further provided with a second curved portion corresponding to the first curved portion, moreover, the curved section is formed from the first curved portion and the second curved portion.

9. The method for manufacturing an elastic structure between two objects according to claim 8, wherein the first curved portion assumes a protruding portion inside the first groove, and the second curved portion assumes an indented portion inside the second groove.

10. The method for manufacturing an elastic structure between two objects according to claim 9, wherein the flow channel is located on the first mold seat to afford passage to the first groove.
